(19) United States
(12) Patent Application Publication
(10) Pub. No.: US 2026/0313175 A1
(43) Pub. Date: Oct. 8, 2026

(54) SERVER-SIDE INITIATION AND PLAYBACK OF PRIMARY AND SECONDARY MEDIA CONTENT

(71) Applicant: GOOGLE LLC, Mountain View, CA (US)

(72) Inventors: Pawel Czeslaw Jurczyk, Newton, MA (US); Benjamin Scott Hulse, Moss Beach, CA (US); Yun Shi, Sunnyvale, CA (US); Tristan Schmelcher, Sammamish, WA (US); Dragos Ciprian Ionescu, Boston, MA (US); Zheng Zhang, Danville, CA (US); Rupert Nkomo Webb, Milton, MA (US)

(21) Appl. No.: 19/483,571

(22) PCT Filed: May 12, 2023
(86) PCT No.: PCT/US2023/022131

§ 371 Date: Nov. 11, 2025

(51) Int. Cl. H04N 21/234; H04N 21/239; H04N 21/262; H04N 21/431; H04N 21/472

(52) U.S. Cl. CPC H04N 21/23424; H04N 21/2393; H04N 21/262; H04N 21/431; H04N 21/47217

(57) ABSTRACT

A request for a media segment of a media stream to be delivered to a client is received at a server. Whether the requested media segment is to include primary media content or secondary media content is determined using a server-based timeline of the media stream. The timeline defines one or more positions in the media stream to include the secondary media content. A secondary media content item is obtained by the server in response to determining that the requested media segment corresponds to a position of the one or more positions defined in the timeline. A media segment of the secondary media content item is added to the media stream to provide the requested media segment to the client.

### TECHNICAL FIELD

Aspects and implementations of the present disclosure relate to streaming media, and in particular to server-side initiation and playback of primary and secondary media content.

### BACKGROUND

Streaming refers to the process of continuously delivering media content (e.g., video, audio) to a recipient as the recipient is simultaneously consuming the media content. In an illustrative example, a server device may stream a video to a client device by breaking the video data into segments and sending the segments sequentially over a network to the client device. The client device may present the received segments to a user as soon as the segments arrive at the client device, or the client may store segments in a buffer for presenting at a later time.

Streaming platforms may support a variety of client devices and network conditions. For example, streaming platforms may support different streaming formats (e.g., H.264/AVC, VP9, H.265/HEVC, AV1, ACC, MP3) and adaptive bitrate (ABR) streaming ABR techniques enable the server to detect current bandwidth conditions of the network or client device and increase or decrease the bitrate of the stream to match the current bandwidth. The bitrate of a stream may be modified, for example, by changing the quality (e.g., resolution, frame rate) of the media content. Techniques such as ABR may reduce the user's perception of buffering at the client device, where bitrates in excess of present bandwidth cause the stream to fall behind the client-side presentation of the media content, resulting in pauses in the user's viewing experience as the client-side buffer refills. Streaming platforms may further use techniques such as digital rights management (DRM) and encryption to manage access to media content.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for initiation and playback of secondary media content for streaming platforms. In an implementation, a method includes receiving, at a server, a request for a media segment of a media stream to be delivered to a client. The method further includes determining, using a server-based timeline of the media stream, whether the requested media segment is to include primary media content or secondary media content. The timeline defines one or more positions in the media stream to include the secondary media content. The method further includes responsive to determining that the requested media segment corresponds to a position of the one or more positions defined in the timeline, obtaining, by the server, a secondary media content time. The method further includes adding a media segment of the secondary media content item to the media stream to provide the requested media segment to the client. In some embodiments, the server-based timeline is synchronized to a plurality of timeline servers.

In some embodiments, a method further includes sending metadata associated with the secondary media content item to the client, wherein the metadata corresponds to one or more graphical user interface (GUI) elements to be presented at the client with the secondary media content item.

In some embodiments, a method further includes sending the timeline of the media stream to the client, wherein the timeline of the media stream indicates one or more permitted seeking actions available to a user of the client.

In some embodiments, a method further includes receiving, at the server, an indication of a permitted seeking action performed by the user of the client. The method further includes updating the server-based timeline of the media stream based on the indication of the permitted seeking action performed by the user of the client. The method further includes receiving, at the server, a request for a second media segment of the media stream to be delivered to the client. The method further includes determining, using the updated server-based timeline of the media stream, whether the requested second media segment is to include primary media content or secondary media content.

In some embodiments, a method further includes receiving, at the server, an indication of a non-permitted seeking action performed by the user of the client. The method further includes receiving, at the server, a request for a second media segment of the media stream to be delivered to the client. The method further includes determining, using the server-based timeline of the media stream and irrespective of the indication of the non-permitted seeking action performed by the user of the client, whether the requested second media segment is to include primary media content or secondary media content.

In some embodiments, obtaining the secondary media content item includes requesting, by the server, selection of one of a plurality of secondary media content items by a secondary media content server, and receiving the secondary media content item from the secondary media content server.

In some embodiments, a previous media segment of the media stream is associated with a first format. The media segment of the secondary media content item is associated with a second format. Adding the media segment of the secondary media content item to the media stream includes prepending an initialization segment to the media segment of the secondary media content item. The initialization segment causes the client to reinitialize a decoder of the client to decode the second format.

In some embodiments a computer-readable storage medium (which may be non-transitory computer-readable storage medium, although the invention is not limited to that) stores instructions which, when executed, cause a processing device to perform operations comprising a method according to any embodiment or aspect described herein.

In some embodiments a system comprises: a memory; and a processing device operatively coupled with the memory to perform operations comprising a method according to any embodiment or aspect described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example streaming platform system architecture that provides server-side initiation and playback of primary and secondary media content, in accordance with at least one embodiment of the present disclosure.

FIG. 2 illustrates an example client device of a streaming platform, in accordance with at least one embodiment.

FIGS. 3A-B illustrate example media stream timelines for server-side initiation of primary and secondary media content, in accordance with at least one embodiment.

FIGS. 4A-B illustrate example media streams for server-side playback of primary and secondary media content, in accordance with at least one embodiment.

FIGS. 5A-C depict flow diagrams of example methods for providing server-side initiation and playback of primary and secondary media content at a streaming platform, in accordance with at least one embodiment.

FIG. 6 is a block diagram illustrating an exemplary computer system, in accordance with at least one embodiment of the present disclosure.

### DETAILED DESCRIPTION

Aspects of the present disclosure relate to server-side initiation and playback of primary and secondary media content. Streaming experiences may include primary media content and secondary media content. Examples of primary media content include live video or audio (e.g., live TV, music concerts, etc.) and media on demand (e.g., video on demand or VOD, recorded music, playlists of videos or music, etc.). Primary content may range in length from a few seconds (e.g., video shorts) to continuous or endless content (e.g., nature streams). Secondary media content may be positioned at the beginning or the end of primary content (e.g., pre-roll or post-roll) or may be positioned within the primary media content as a break or interruption (e.g., mid-roll). Examples of secondary media content include advertisements, informational segments or announcements, surveys, and links to other media streams. Secondary media content may also vary in length, and multiple secondary media content items may be positioned within or around a single primary media content item (e.g., multiple commercials in a single live TV program). Both primary and secondary media content may be interactive. For example, playback controls (e.g., play, pause, skip forward/backward, volume control) may be positioned inside or outside the viewable content area. In another example, secondary media content may include survey answers that can be selected by a user (e.g., via clicking or tapping). Secondary media content items for a given media stream may be predetermined (e.g., before streaming starts) or may be determined shortly before each secondary media content item is to be presented. In the latter case, media streams may include placeholders of fixed or variable length to be filled with secondary media content items at the appropriate time. For example, ad auctions may be conducted shortly before an advertisement slot is to be streamed in order to determine which advertisement will fill the slot.

In conventional systems, primary media content and secondary media content may be streamed to client devices as separate media streams, where they are combined (e.g., stitched) into a single continuous viewing experience for users with a primary-to-secondary media content transition (or vice versa). For example, live TV content may be streamed from a live TV server of a streaming platform, and advertisements may be streamed from an ad server of the streaming platform or a third-party advertising platform. These separate streams may be encoded in different formats, encrypted with different DRM keys, or may have other incompatibilities that prevent the client device from simply appending the data from one stream to the end of the data from the other stream to perform the primary-to-secondary media content transition. Thus, in some situations the client device may initialize two media players (one for each format or DRM key) and swap them out during the content transition, or the client device may reinitialize a media player during the content transition to decode a different format. These operations may introduce noticeable latency on the client device during the content transition, which may negatively impact the user experience. Supporting client-side primary-to-secondary media content transitions may also be burdensome for streaming platform developers, who often may develop and maintain bespoke implementations of the transition logic for each client device the platform supports (e.g., smartphones, tablets, smart TVs, etc.). This may increase the likelihood of software or hardware bugs being present in some implementations, which may also negatively impact the user experience. These challenges may lead to needless consumption of computing resources on both clients and servers, excessive use of network bandwidth, and excessive strain on developer time and resources, any of which may lead to increased expenses for streaming platforms.

Another challenge in conventional systems relates to determining which secondary media content item(s) to present at client devices. Client devices often control this process in conventional systems. A client device may maintain a local timeline of the media stream, which may define the positions to include secondary media content. Using the local timeline, the client device may request secondary media content items from servers at appropriate times to fill the defined positions. For example, the client device may initiate an ad auction, request an interactive survey, etc. In some systems, clients may make multiple requests in sequence to obtain secondary media content items, consuming additional network bandwidth for more round trips and exacerbating transition latency issues. For example, a client may first contact one server to initiate an ad auction and receive an identifier for the selected advertisement, and then the client may contact a second server to begin streaming the identified advertisement. Client-side systems such as the above examples may lead to needless use of computing resources and network bandwidth, excessive latency, and poor user experience, as well as challenges associated with developing bespoke implementations for client-side systems as previously described (e.g., increased developer time/cost, increased likelihood of bugs). Furthermore, client-side implementations may be susceptible to undesired manipulation by users or other client-side software or hardware. For example, software may manipulate the client-local timeline to remove secondary content or may block requests to secondary content servers. These manipulations may impact the normal functioning of the streaming system, which may introduce additional burdens for streaming platforms and negatively impact the user experience.

Aspects of the present disclosure address the above and other deficiencies by providing server-side initiation and playback of primary and secondary media content. Streaming platforms and other streaming systems or services utilizing the techniques described herein may include a server-side media stream timeline for determining whether to stream primary or secondary media content and to initiate selection of media content. Streaming platforms may also include a streaming server for server-side play back of media streams, which may provide server-side stitching or encapsulation of primary and/or secondary media content to generate a media stream for a client. Streaming platforms may further generate metadata delineating boundaries between primary and secondary media content items in a server-stitched media stream and including graphical user interface (GUI) elements for secondary media content items.

In at least one embodiment, server-side media stream timelines are provided. Server-side media stream timelines may be created and updated by the streaming platform and may define positions for primary and secondary media content within the timeline. Media stream timelines may further indicate a current playback position (e.g., with respect to the current media content item or the whole media stream) and permitted or non-permitted user actions (e.g., seeking actions) for different media content items. The streaming platform may query the server-side timeline to determine the next content item to be streamed in response to requests from clients for additional media segments of the media stream. The streaming platform may then select and obtain the next media content item. The streaming platform may update the server-side timeline based on permitted user seeking actions and may ignore non-permitted user seeking actions, thereby providing a definitive timeline for the media stream. Server-side media stream timelines may further be shared between multiple users, and content items of a media stream timeline can be customized for each user based on user or client device characteristics.

In at lest one embodiment, server-side stitching and encapsulation of media streams are provided. Server-side stitching of media streams may include joining primary and secondary media content items encoded in the same format such that a media segment of one content item is appended to a media segment of the other content item, creating a single media stream in one format. Server-side encapsulation of media streams may include joining primary and secondary media content items encoded in different formats such that a media segment of one content item is preceded by an initialization segment, and the content item with initialization segment is appended to a media segment of the other content item to create a single media stream with two formats. The initialization segment causes the client to reinitialize a decoder or media player to switch from decoding the first format to decoding the second format. In both stitched and encapsulated streams, only a single stream containing all primary and secondary media content items is streamed to clients.

In at least one embodiment, media stream metadata are provided. Media stream metadata may include a copy of the server-side media stream timeline to be sent to the client. Media stream metadata may also include indications of whether the server is currently streaming primary or secondary media content and may further include GUI elements to be presented to the user in association with the currently presented media content item. The metadata may cause the client device to update a local progress bar showing the current playback time of the current media content item, present “skip” buttons or links, or conduct other local updates. Media stream metadata may also instruct the client device to perform certain activities, such as logging data related to engagement with secondary media content.

Accordingly, streaming platforms using the techniques described herein can provide improved streaming experiences that include primary and secondary media content. Server-side initiation and selection of secondary media content can reduce client requests and round trips to the server and can also reduce interference from other client-side software. Shared server-side timelines can reduce computational load on streaming platforms and can adapt to user interests or client device limitations. Server-side playback of media streams can also reduce client network connections and reduce computational loads on client devices. Both server-side initiation and playback of media streams can reduce the amount of software that streaming platform developers should create and maintain by reducing the software footprint on client devices. Thus, streaming platforms may experience reduced latency (e.g., network latency and transition latency), reduced use of computing resources, improved developer efficiency, and reduced operating costs, which may benefit both users and streaming platforms.

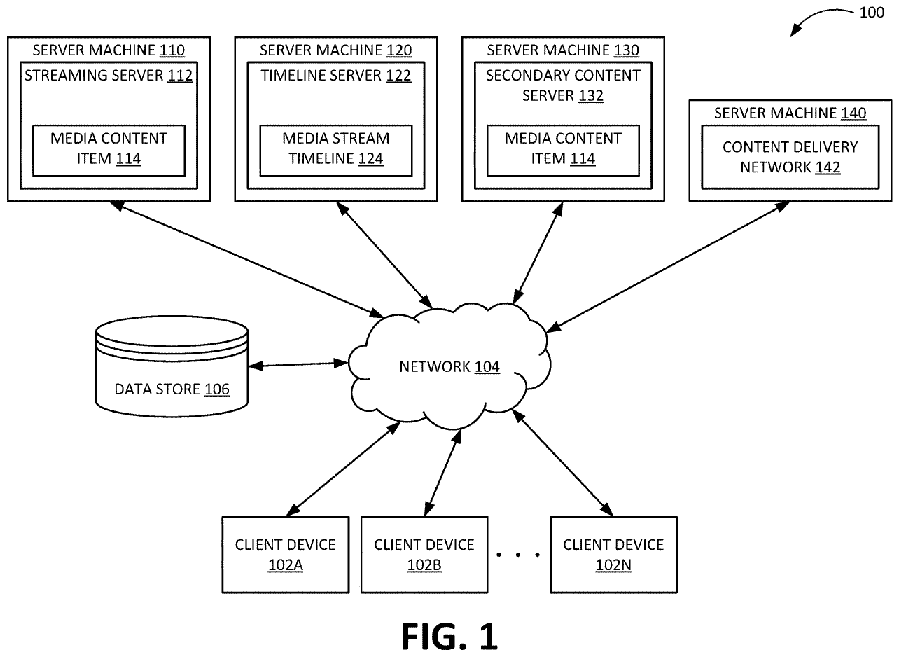

FIG. 1 illustrates an example streaming platform system architecture 100 providing server-side initiation and playback of primary and secondary media content. System architecture 100 (also referred to as “system” or “streaming platform” herein) includes one or more server machines 110-140, data store 106, and client devices 102A-N connected to network 104. In some implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. For example, network 104 may include a private enterprise network connecting data store 106 and one or more of server machines 110-140, and the private enterprise network may in turn be connected to client devices 102A-N via the Internet. In some embodiments, network 104 may be a physical or virtual interconnect within a single server providing all of the components of one or more of server machines 110-140 For example, network 104 may be a PCIe bus, a messaging system, or an API.

Data store 106 is a persistent storage that is capable of storing streaming platform content such as primary and secondary media content items, user profiles and preferences, system configurations and settings, log data, etc. Data store 106 may be hosted by one or more storage devices, such as main memory, magnetic or optical storage-based disks, tapes or hard drives, NAS, SAN, and so forth. In some embodiments, data store 106 may be a network-attached file server. In some embodiments, data store 106 may be some other type of persistent storage such as an object-oriented database, a relational database, and so forth. In some embodiments, data store 106 may be hosted on or may be a component of one or more of server machines 110-140. In some embodiments, data store 106 may be provided by a third-party service such as a cloud platform provider.

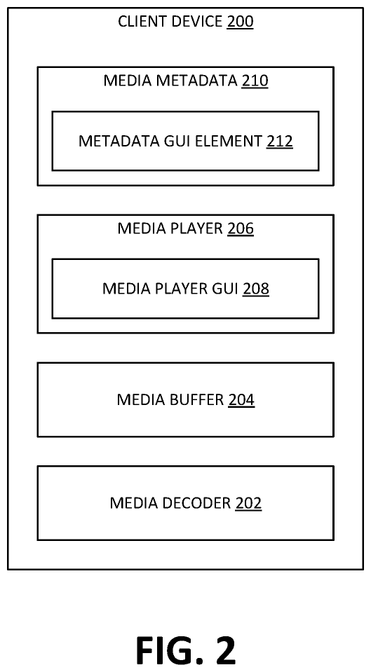

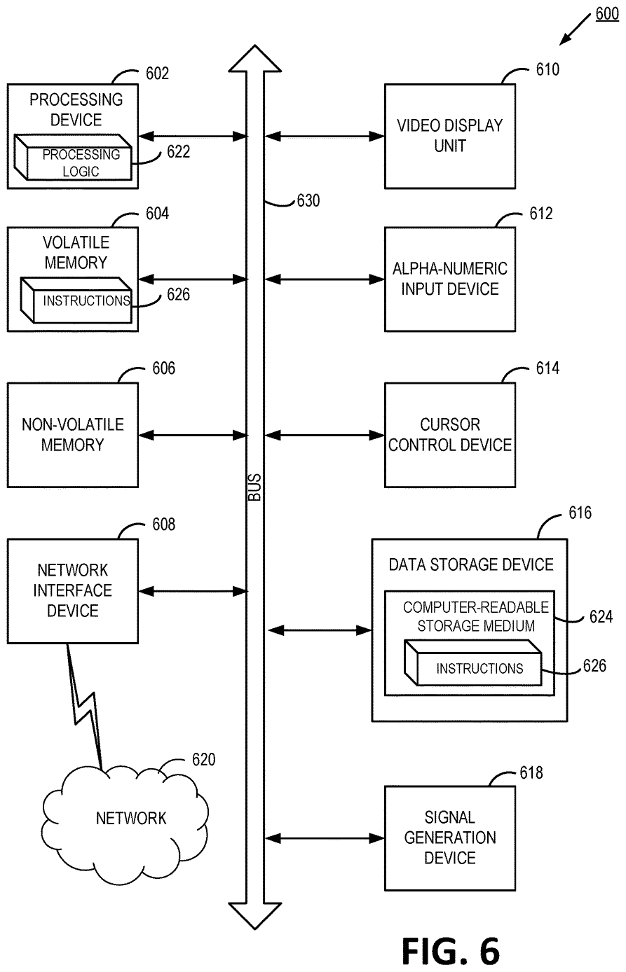

Client devices 102A-N may be personal computers (PCs), laptops, notebook computers, mobile phones, smartphones, tablet computers, digital assistants, network-connected televisions (e.g., smart TVs), or any other computing devices. The computer system of FIG. 6 may be an example of a client device. In some implementations, client devices 102A-N may also be referred to as “user devices.” Client devices 102A-N may run an operating system (OS) that manages hardware and software of client devices 102A-N. Client devices 102A-N may further include a web browser, application, or other software for streaming media content. Client devices 102A-N may be used by users such as viewers of a streaming platform. An example client device is further described with respect to FIG. 2.

Each of server machines 110-140 may be a rackmount server, a router computer, a personal computer, a portable digital assistant, a mobile phone, a laptop computer, a tablet computer, a netbook, a desktop computer, a virtual machine (VM), etc., or any combination of the above. The computer system of FIG. 6 may be an example of a server machine. In some embodiments, one or more of server machines 110-140 may be combined into a single server machine providing all of the components of the individual server machines depicted in FIG. 1. In some embodiments, each of server machines 110-140 may be several computing devices, such as multiple rackmount servers in a data center(s) or multiple VMs in a cloud platform.

Server machine 110 includes streaming server 112, which may provide streaming functions for the streaming platform. Streaming functions may include receiving client requests to initiate media streams or to stream a media segment, querying server-side timelines, determining types of media content and selecting media content items to stream, obtaining media content items from local or remote storage (e.g., data store 106 or secondary content server 132), adding media segments to media streams (e.g., via stitching or encapsulation), adding DRM protections to media streams, and various other activities. Streaming server 112 may manage multiple active media streams for multiple clients. In some embodiments, a single media stream managed by streaming server 112 may be associated with multiple clients (e.g., a live TV program).

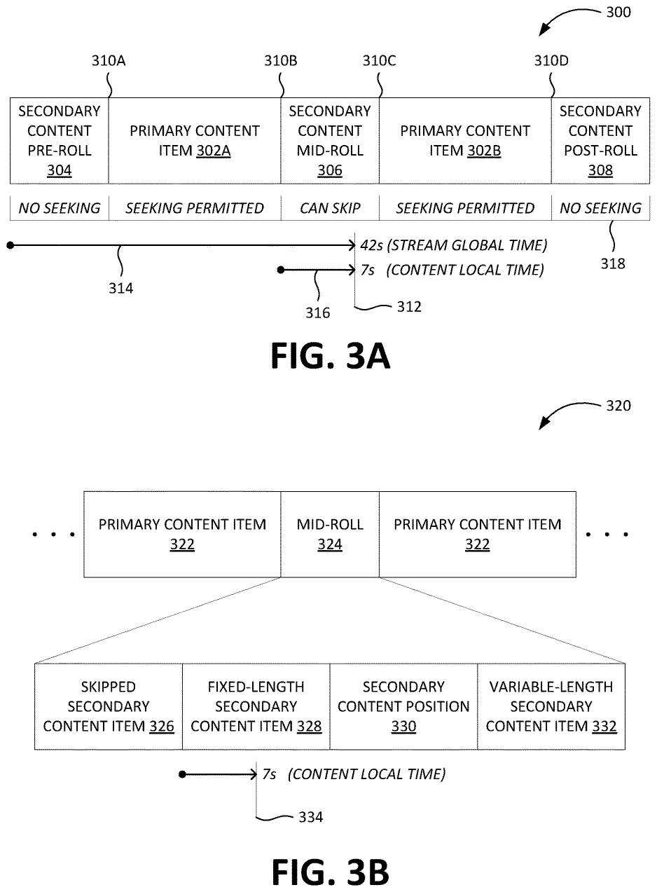

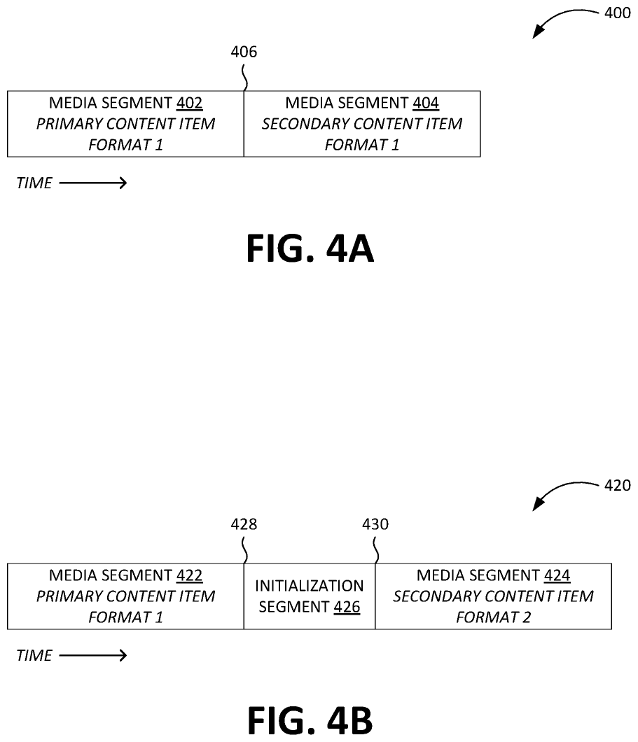

Streaming server 112 may include one or more media content items such as media content item 114. Media content item 114 may be a primary media content item (e.g., live TV program, VOD, music track) or a secondary media content item (e.g., advertisement, announcement, survey). Media content item 114 can be consumed via the Internet or via a mobile device application, such as media player 206 of client device 200 described with respect to FIG. 2. In some embodiments, media content item 114 can correspond to a media file (e.g., a video file, an audio file, a video stream, an audio stream, etc.). In other or similar embodiments, media content item 114 can correspond to a portion of a media file (e.g., a portion or a chunk of a video file, an audio file, etc.). As used herein, “media,” “media item,” “multimedia item,” “online media item,” “digital media,” “digital media item,” “content,” “multimedia content,” and “content item” can include an electronic file that can be executed or loaded using software, firmware or hardware configured to present the digital media item to an entity. Streaming server 112 can store media content item 114, or a reference to media content item 114, using data store 106, in at least one implementation. In another implementation, streaming server 112 can store media content item 114 or a fingerprint as an electronic file in one or more formats (e.g., H.264/AVC, VP9, H.265/HEVC, AV1, ACC, MP3) using data store 106. Streaming server 112 can provide media content item 114 to a user associated with one of client devices 102A-N by allowing access to media content item 114 (e.g., via a streaming platform application), transmitting the media content item 114 to the client device, and/or presenting or permitting presentation of the media content item 114 via the client device. Streaming to client devices is further described with respect to FIGS. 3 and 4.

In some embodiments, media content item 114 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional, and three-dimensional video. Further, video items can include movies, video clips, video streams, or any set of images (e.g., animated images, non-animated images, etc.) to be displayed in sequence. In some embodiments, a video item can be stored (e.g., at data store 106) as a video file that includes a video component and an audio component. The video component can include video data that corresponds to one or more sequential video frames of the video item. The audio component can include audio data that corresponds to the video data.

In some embodiments, media content item 114 may be associated with metadata. Metadata may include title, author, channel, captions, comments from other users, etc. related to media content item 114. Metadata may also include timeline-related information, such as a current playback position, most-watched or most-interesting time ranges, positions of secondary media content within media content item 114, etc. Metadata may also include GUI elements or identifiers of GUI elements to be presented to the user. For example, metadata may cause the client device to present a skip button, a list of survey options, or a link to the user in association with media content item 114. Metadata may also include directives to the client device to perform one or more actions, such as logging events related to secondary media content items (e.g., user interaction or user engagement).

A streaming platform can include multiple channels (e.g., channels A through Z). A channel can include one or more media content items 114 available from a common source or media content items 114 having a common topic, theme, or substance. Media content items 114 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third-party platforms (not shown). In some embodiments, a third-party platform can provide other services associated with media content items 114. For example, a third-party platform can include an advertisement platform that can provide video and/or audio advertisements, which may be uploaded to secondary content server 132 described below. In another example, a third-party platform can be a video streaming service provider that produces a media streaming service via a communication application for users to play videos, TV shows, video clips, audio, audio clips, and movies, on client devices 102A-N via the third-party platform.

Server machine 120 includes timeline server 122, which may provide server-side timeline management for the streaming platform. Timeline server 122 includes media stream timeline 124, which defines the order and relative positions of primary and secondary media content items in a media stream, the current playback location in timeline, and other features relevant to the media stream. Timelines are further described with respect to FIGS. 3A-B. Timeline server 122 may include multiple media stream timelines 124, e.g., one for each client device 102A-N or one for each active stream managed by streaming server 112. In some embodiments, a single media stream timeline 124 may be associated with multiple client devices 102A-N. For example, a live TV program (e.g., a sporting event or music concert) may have a timeline that all users follow.

Timeline server 122 may communicate with streaming server 112 and/or client devices 102A-N to provide information related to media stream timeline 124 or to update media stream timeline 124. For example, streaming server 112 may query timeline server 122 to determine the current playback position or next media content item to fetch from data store 106. In another example, streaming server 112 may send a request to timeline server 122 to move the current playback position back in response to a seeking action. In yet another example, timeline server 122 may send a copy of media stream timeline 124 to a client device (e.g., client devices 102A-N) in response to a request from the client device. In some embodiments, streaming server 112 may act as an intermediary between client devices 102A-N and timeline server 122 (e.g., for copying the timeline to the client in the previous example), whereas timeline server 122 may be directly accessible to client devices 102A-N in other embodiments. In some embodiments, timeline server 122 and/or media stream timeline 124 may define permitted actions with respect to the timeline and/or block non-permitted actions. For example, a user seeking action may be permitted when the current playback position is within a primary content item, but a user seeking action may be disallowed when the current playback position is within a secondary content item or when the seeking action skips over a secondary content item. In some embodiments, timeline server 122 may communicate with other timeline servers (not depicted) to replicate and synchronize media stream timeline 124, such that any timeline server may provide media stream timeline 124 and associated data or metadata to streaming server 112 and/or client devices 102A-N. Timeline replication may be beneficial for providing redundancy and maintaining integrity of the timeline, as well as for preventing tampering with the timeline at client devices 102A-N and/or by third-parties.

Server machine 130 includes secondary content server 132, which may select and/or provide secondary media content items for the streaming platform. Secondary content server 132 may contain one or more media content items 114, which may be secondary content items such as advertisements, announcements, surveys, etc. In some embodiments, secondary content server 132 may respond to requests from streaming server 112 or client devices 102A-N to select a secondary media content item for a media stream. For example, secondary content server 132 may run an ad auction or select a survey from a list of currently available surveys. Requests may include specifications or limitations for secondary media content items. For example, a request may specify a required playback length or encoding format for an advertisement. In some embodiments, secondary content server 132 may serve secondary content items to streaming server 112 or client devices 102A-N. For example, secondary content server 132 may serve a specific advertisement to streaming server 112 for streaming to a client in response to a request for that advertisement from streaming server 112. In some embodiments, secondary content server 132 may be provided by the streaming platform, a third-party secondary content provider, or a combination thereof.

Server machine 140 includes content delivery network 142 (also content distribution network, or CDN), which may provide content distribution services for the streaming platform. In some embodiments, CDN 142 may comprise multiple nodes (e.g., multiple server machines 140, multiple data centers) geographically distributed to be close to users such as client devices 102A-N. These nodes may act as proxies or relays for centralized servers of the streaming service (e.g., server machines 110-130) and may provide features such as caching media content items, timelines, and other data of the streaming service. CDN 142 may provide the advantages of reduced latency experienced by users, improved use of network bandwidth, reduced load on centralized servers, and redundancy in the event of network interruptions or failed/overloaded centralized servers or CDN nodes. For example, CDN 142 may cache a media content item streamed to a first user from streaming server 112, and subsequent requests for the same media content item by other local users may be served by CDN 142 rather than streaming server 112. In some embodiments, CDN 142 may be transparent to users and/or the streaming platform, and thus functionality described herein as being performed by server machines 110-130 may also be performed by CDN 142. For example, server machines 110-130 (or states thereof) may be replicated at one or more nodes of CDN 142. In an additional example, media stream timeline 124 may be replicated and synchronized between replica timeline servers 122 at one or more nodes of CDN 142, which may enable a media stream to transition between nodes (e.g., when a node fails or when a client moves to a new geographic location) while maintaining integrity of the associated media stream timeline 124. Similarly, other aspects of the streaming platform may be replicated and synchronized across CDN 142. In some embodiments, CDN 142 may be provided by the streaming platform, a third-party CDN provider, or a combination thereof. In some embodiments, CDN 142 may be absent, and all communications from client devices 102A-N are directed to centralized servers (e.g., server machines 110-130).

In general, functions described in implementations as being performed by a streaming platform and/or server machines 110-140 can also be performed on the client devices 102A-N in other implementations. In addition, the functionality attributed to a particular component can be performed by different or multiple components operating together. A streaming platform can also be accessed as a service provided to other systems or devices through appropriate application programming interfaces, and thus is not limited to use in websites.

Although implementations of the disclosure are discussed in terms of a streaming platform and users of a streaming platform accessing an electronic document, implementations can also be generally applied to any type of documents or files. Implementations of the disclosure are not limited to electronic document platforms that provide document creation, editing, and/or viewing tools to users. Further, implementations of the disclosure are not limited to text objects or drawing objects and can be applied to other types of objects.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of a streaming platform.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before itis stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 illustrates an example client device 200, in accordance with at least one embodiment. Client device 200 may correspond to one or more of client devices 102A-N of FIG. 1. Client device 200 includes media decoder 202, media buffer 204, media player 206 with associated media player GUI 208, and media metadata 210 associated with metadata GUI element 212. In some embodiments, client device 200 may contain more, fewer, or different components than those depicted in FIG. 2. For example, client device 200 may include processors, memory, storage, peripherals, and other components described with respect to FIG. 6.

Media decoder 202 may be a hardware component, a software component, or a mix of hardware and software components that decodes media streams in various formats such as H.264/AVC, VP9, H.265/HEVC, AV1, ACC, MP3, etc. In some embodiments, media decoder 202 may support decoding a single format, while in other embodiments media decoder 202 may support decoding multiple formats. In some embodiments, media decoder 202 may provide initialization or reset capabilities to change an active decoding format from a first format (e.g., AVC) to a second format (e.g., HEVC). In some embodiments, media decoder 202 may support decoding multiple streams in parallel (potentially in different formats). For example, media decoder 202 may support simultaneously decoding video and audio streams. In some embodiments, client device 200 may include multiple media decoders 202 for decoding multiple streams in parallel. In some embodiments, media decoder 202 may provide decryption or other capabilities associated with removing DRM protection from media streams, e.g., using a key provided by the streaming platform. In some embodiments, DRM decryption may be provided by another component of client device 200 (not depicted in FIG. 2).

Media buffer 204 may be a hardware buffer, a section of memory (e.g., physical memory or virtual memory), or other storage area for storing media stream data before it is presented to a user. In some embodiments, media buffer 204 may store encoded stream data before it is decoded by media decoder 202. In some embodiments, media buffer 204 may store decoded stream data after it is decoded by media decoder 202. In some embodiments, media buffer 204 may store data from multiple media streams. In some embodiments, client device 200 may include multiple media buffers 204 for storing data from multiple media streams before presenting the media streams to the user.

Media player 206 may be a software component that manages aspects of retrieving and presenting media streams. Media player 206 may communicate with a streaming platform (e.g., streaming server 112 of FIG. 1) to initiate a stream or request subsequent media segments. Media player 206 may also communicate with or configure media decoder 202 and media buffer 204 to decode and temporarily store streamed media segments before presenting them to a user. Media player 206 includes media player GUI 208 for providing playback of the media stream to the user and receiving user input for interacting with the media stream. Media player may provide non-graphical user interfaces as well, such as playing audio streams and receiving user audio via an audio input device (e.g., microphone) of client device 200. In some embodiments, media player 206 may be received from the streaming platform in response to client device 200 initiating a request for a new media stream. In some embodiments, client device 200 may include multiple media players 206. Each media player 206 may be associated with different media decoders 202 or media buffers 204, and media player GUIs 208 may be visible or hidden for each media player 206. For example, a first media player may be associated with a media buffer and a media decoder for an AVC-encoded media stream, and a second media player may be associated with a media buffer and media decoder for an HEVC-encoded media stream. The first media player GUI may be visible and the second media player GUI may be hidden while the AVC-encoded media stream is playing, and vice versa while the HEVC-encoded media streaming is playing. Transitions between media streams in similar or different formats are further described with respect to FIGS. 4A-B.

In some embodiments, client device 200 can transmit a request to a streaming platform (e.g., streaming server 112) for access to a media content item (e.g., media content item 114). The request may be, for example, a request to initiate a media stream of the media content item or a request for a media segment of the media stream. The streaming platform may identify the media content item of the request (e.g., at data store 106, etc.) and may provide access to the media content item via media player GUI 208 of media player 206 (which may be provided by the streaming platform). In some embodiments, the requested media content item may have been generated by another client device 200 connected to streaming platform. For example, client device 200 can generate a video item (e.g., via an audiovisual component, such as a camera, of client device 200) and provide the generated video item to the streaming platform (e.g., via a network) to be accessible by other users of the platform. In other or similar embodiments, the requested media content item may have been generated using another device (e.g., that is separate or distinct from client device 200) and transmitted to client device 200 (e.g., via a network, via a bus, etc.). Client device 200 can provide the video item to the streaming platform (e.g., via a network) to be accessible by other users of the platform, as described above. Another client device can transmit the request to the streaming platform (e.g., via a network) to access the video item provided by client device 200, in accordance with the previously provided examples.

In some embodiments, media player GUI 208 of media player 206 (which may be provided by the streaming platform) may include one or more GUI elements that enable a user to control a playback of a media stream via media player 206. For example, media player GUI 208 may include one or more GUI elements that enable the user to initiate playback of the media stream (e.g., a “play” button) and/or pause playback of the media stream (e.g., a “pause” button). In another example, media player GUI 208 may include one or more GUI elements that enable the user to initiate streaming of another media content item that is related to the requested media content item (e.g., a “next” button). Media player GUI 208 may further include one or more GUI elements that indicates a timeline of the media stream and/or a progress of the playback of the media content item within the timeline. In some embodiments, the timeline indicated by the GUI elements may correspond to a local copy of a server-based timeline associated with the media stream (e.g., media stream timeline 124 of FIG. 1). Example timelines are further described with respect to FIGS. 3A-B.

In some embodiments, media metadata 210 may be received from a streaming platform (e.g., from streaming server 112) and may be associated with one or more media streams or media segments. Media metadata 210 may include information related to the media stream such as title, author, channel, etc. of the media content items in the media stream. Media metadata 210 may also include timeline-related information, which media player 206 may use to display progress of the playback of the media stream or media content items. Media metadata 210 may also include information about the stream quality, such as current network bandwidth or changes in encoding quality. Media metadata 210 may also include directives causing client device 200 to perform actions related to the media stream, such as logging data or events associated with the media stream. Various other data may be included in media metadata 210. In some embodiments, media metadata 210 may indicate to client device 200 that the current media segment is part of a primary media content item or a secondary media content item. This may be useful when client device 200 cannot otherwise distinguish between primary and secondary media content, e.g., due to the server-side stitching and encapsulation techniques described with respect to FIGS. 4A-B. In some embodiments, the client may retrieve one or more metadata GUI elements 212 from local or remote storage to present in association with the primary or secondary media content as specified in media metadata 210. For example, the GUI element(s) may be a “skip ad” button, a set of radio buttons for a survey, one or more hyperlinks linking to other media content, etc. In some embodiments, media metadata 210 may include one or more metadata GUI elements 212 to be presented at the client. For example, media metadata 210 may include HTML, CSS, XML, JavaScript, etc. to be inserted into the GUI of client device 200.

FIGS. 3A-B illustrate example media stream timelines 300 and 320 for server-side initiation of primary and secondary media content, in accordance with at least one embodiment. Example media stream timelines 300 and 320 may be server-side timelines maintained at a streaming server (e.g., streaming server 112 of FIG. 1), a timeline server (e.g., timeline server 122), a CDN (e.g., CDN 142), or elsewhere within a streaming platform.

Referring to FIG. 3A, example media stream timeline 300 represents primary media content item(s) 302A-B. In some embodiments, a media stream timeline may represent a single primary media content item 302A-B, which may be divided into two or more parts. For example, 302A may be a first part of a primary media content item preceding an advertisement, and 302B may be a second part following the advertisement. In some embodiments, a media stream timeline may include multiple primary media content items 302A-B. For example, a live TV channel may have a first program (302A) preceding a commercial break and a second program (302B) following the commercial break. In an additional example, a playlist may include multiple videos, video shorts, songs, etc. represented by two or more primary media content items 302A-B. Media stream timeline 300 further includes secondary media content positions: secondary media content pre-roll 304, secondary media content mid-roll 306, and secondary media content post-roll 308. Each of secondary media content positions 304-308 may include one or more secondary media content items (or positions for those items) as described with respect to FIG. 3B below. In some embodiments, a media stream timeline may have fewer than the three depicted secondary media content positions, such as one or two of pre-roll, mid-roll, and post-roll media content positions. In some embodiments, a media stream timeline may have more than the three depicted secondary media content positions, such as additional secondary media content mid-roll positions 306 dividing the primary media content item(s) into three or more parts. Media stream timeline 300 may indicate transitions between primary and secondary media content, such as at transitions 310A-D. Transitions between primary and secondary media content are relevant with respect to server-side playback of media streams as described with respect to FIGS. 4A-B.

Media stream timeline 300 may indicate a current playback position 312 of the stream, which may be with respect to a stream global playback time 314 and/or a content local playback time 316. Playback positions, playback times, transition times (e.g., 310A-D), and other information may be stored as data or metadata associated with media stream timeline 300. In some embodiments, this information may be provided to a client device and may be used to render global or local progress bars as described with respect to FIG. 2. Media stream timeline 300 may further describe permitted or non-permitted user/client actions with respect to the timeline, such as seeking within or skipping media content (e.g., at 318). In some embodiments, this information may be provided to a client device and may be used to render available user interactions. The streaming platform may also use this information in response to client requests to update the timeline or provide media segments from a different playback position on the timeline in order to determine if such requests are permitted or non-permitted. In some embodiments, the streaming platform may update media stream timeline 300 automatically in the absence of client activity. For example, secondary media content (e.g., pre-roll 304) may be automatically removed from media stream timeline 300 after the secondary media content has fully played through to prevent the secondary media content from being played again should the user seek back to a time at or before the beginning position of the secondary media content.

Referring to FIG. 3B, example media stream timeline 320 includes primary media content item 322 and secondary media content mid-roll 324. Media stream timelines may include multiple secondary media content items in sequence, such as in pre-roll, mid-roll, or post-roll positions. Mid-roll 324 demonstrates a variety of timeline characteristics related to secondary media content. In some embodiments, mid-rolls and other secondary media content positions may include more or less secondary media content than that depicted in FIG. 3B. In some embodiments, the examples in mid-roll 324 may apply to primary media content.

Mid-roll 324 includes skipped secondary media content item 326. A secondary media content item may be skipped, for example, by a permitted user seeking action on a client device. In some embodiments, metadata associated with the media stream (e.g., media metadata 210 of FIG. 2) may include a “skip” GUI element that enables the user to skip the secondary media content item. In some embodiments, in response to skipping a secondary media content item, the streaming platform may update the timeline by moving the current playback position to the next primary or secondary media content item (e.g., current playback position 334 in fixed-length secondary media content item 328). The streaming platform may remove skipped secondary media content item 326 from the timeline, which may prevent skipped secondary media content item 326 from being repeated should the user later seek to a position in the timeline preceding skipped secondary media content item 326. In some embodiments, in response to skipping a secondary media content item, the streaming platform may replace skipped secondary media content item 326 with another secondary media content item and stream the replacement instead (not depicted in FIG. 3B). For example, a live TV stream may designate a fixed amount of time for a commercial break comprising one or more advertisements. If a user skips an advertisement, the streaming platform may replace the skipped advertisement with another advertisement to maintain the fixed length of the commercial break.

Mid-roll 324 includes fixed-length secondary media content item 328. Examples of fixed-length secondary media content items include fixed-length advertisements and announcements, as well as surveys, links, and other static content that may be time-limited. Seeking actions may or may not be permitted in fixed-length secondary media content items.

Mid-roll 324 includes secondary media content position 330. In some embodiments, a media stream timeline may designate one or positions to be filled by fixed-length or variable-length secondary media content items without initially selecting the secondary media content items. In some embodiments, secondary content media positions may be filled by media content items selected by the streaming platform. Selections may be made during the time between initialization of the media stream timeline and presentation of the secondary media content position. For example, the streaming platform may query an ad server (e.g., secondary content server 132 of FIG. 1) to initiate an ad auction and select an advertisement. The ad auction and/or selection may occur when the current playback position is sufficiently close to the secondary media content position (e.g., when current playback position 334 is within the preceding secondary media content item, fixed-length secondary media content item 328). In some embodiments, secondary media content positions may be filled based on user or client device characteristics. For example, a live TV media stream viewed by many users may designate secondary media content positions shared by all users (e.g., fixed-length commercial breaks), and the secondary media content positions may be filled with secondary media content items unique to each user based on each user's interests. In an additional example, secondary media content positions may be filled based on client devices' decoding capabilities. For example, a client device may not support decoding a first format used by a first secondary media content item, so the streaming may select an alternate secondary media content item encoded in a second format that is supported by the client device.

Mid-roll 324 includes variable-length secondary media content item 332. Examples of variable-length secondary media content items include surveys, links to other media content, and static content that may not be time-limited or may vary in presentation time based on user interaction. Seeking actions may or may not be permitted in variable-length secondary media content items.

Server-side initiation of primary and secondary media content items using a server-side media stream timeline may provide various advantages. By initiating ad auctions, selecting primary and secondary media content items, obtaining media content items, and performing other initiation activities on the server side, client devices may make fewer requests to the streaming platform. This may result in reduced latency experienced by users (e.g., due to fewer round-trip communication cycles), reduced computational load on client devices, and improved use of network bandwidth. Similarly, a streaming platform may be able to reduce loads on secondary content servers by reusing secondary media content items or selections thereof from previous calls to the secondary content servers (e.g., by serving the same advertisements to multiple viewers of a live TV program). Furthermore, performing initiation activities on the server side may reduce the ability of ad blockers and other software on client devices to interfere with the normal functioning of the streaming platform, which may in turn improve the user experience. Streaming platform developers may also experience increased efficiency and spend less time maintaining and debugging multiple device-specific implementations of client-side initiation activities. For example, streaming platform developers may focus on maintaining a single server-side implementation of ad auctions rather than separate implementations for web browsers, smartphone applications, and smart TVs. Improved developer efficiency may in turn bring benefits to user experience and computational and network efficiency.

FIGS. 4A-B illustrate example media streams 400 and 420 for server-side playback of primary and secondary media content, in accordance with at least one embodiment. Example media streams 400 and 420 demonstrate joining a primary media content item and a secondary media content item at a streaming platform (e.g., at streaming server 112 of FIG. 1), which may correspond to a section of a media stream timeline where a primary media content item transitions to a secondary media content item (e.g., as depicted in FIG. 3A at 310B). Example media streams 400 and 420 may also apply to other media content transitions, such as primary to primary, secondary to primary, and secondary to secondary. In some embodiments, a full media stream may comprise multiple transitions, which may be a mix of the transitions depicted in FIGS. 4A-B.

Referring to FIG. 4A and example media stream 400, media segments 402 and 404 may be joined at transition 406. Media segment 402 may be a media segment of a primary media content item, which may be in a first format (e.g., AVC). Media segment 404 may be a media segment of a secondary media content item, which may also be in the first format. The streaming platform may perform the join at transition 406 by appending the data of media segment 404 to the media stream after the data of media segment 402. In some embodiments, this may be referred to as server-side stitching of media streams. Thus, the media stream may appear to both server and client as a continuous stream of media segments in the first format. From the client's perspective (e.g., client device 200 of FIG. 2), the media decoder will decode both media segments 402 and 404 as if they originated from the same content item, without needing to reset the media decoder or switch media players between media segments. In some embodiments, as described with respect to FIG. 2, the client may rely on metadata to determine which media content items (e.g., primary or secondary) each media segment in associated with. In some embodiments, the client may not need to or may not be permitted to associate media segments with media content items, and thus that information may be retained only in the server.

Referring to FIG. 4B and example media stream 420, media segments 422 and 424 may be joined at transition 428. Media segment 422 may be a media segment of a primary media content item, which may be in a first format (e.g., AVC). Media segment 424 may be a media segment of a secondary media content item, which may be in a second format (e.g., HEVC). The streaming platform may perform the join at transition 428 by prepending initialization segment 426 to media segment 424 at 430 and appending the data of media segment 424 and initialization segment 426 to the media stream after the data of media segment 422. In some embodiments, this may be referred to as server-side encapsulation of media streams. In some embodiments, initialization segment 426 may include instructions or data that cause a media decoder of the client device (e.g., media decoder 202 of FIG. 2) to be reset or reinitialized to decode media segments in the second format instead of the first format. In some embodiments, initialization segment 426 may include instructions or data that cause a media player of the client device (e.g., media player 206 of FIG. 2) to be reset or reinitialized to decode media segments in the second format instead of the first format. In some embodiments, initialization segment 426 may include instructions to switch active decoders and/or media players of the client device. For example, the initialization segment may cause the client device to transition a first-format media player to the background and a second-format media player to the foreground. As described with respect to FIG. 4A, the client device may use metadata or other information to determine which media content items each media segment corresponds to, if such information is permitted and/or useful at the client.

In some embodiments, a streaming platform may apply DRM protection to example media streams 400 and 420 before or after media segments (and initialization segments, if relevant) have been joined. For example, the streaming platform may generate a DRM encryption key and encrypt the joined media stream before streaming to the client. The streaming platform may send a complementary DRM decryption key to the client for removing DRM protection before presenting the media stream to the user (e.g., at media decoder 202 of FIG. 2).

Streaming platforms may provide live and/or on-demand media streams as previously described, and the methods for joining primary and secondary media content items described with respect to example media streams 400 and 420 may provide different advantages for live and on-demand media streams. Live media streams (e.g., a live sports broadcast or music concert) may have many simultaneous clients (e.g., thousands or millions of viewers), and all clients may be following the same or similar media stream timeline. For example, clients may be consuming secondary media content at the same time and may be consuming the same or different secondary media content items (e.g., secondary media content items may be customized for each client). In addition, live media streams may be encoded in a single format streamed to all clients. Thus, it may be beneficial for the streaming platform to identify all potential secondary media content items (in various formats) that may be streamed during the live stream and transcode the content items ahead of time to the same format as the media stream. The streaming platform may use the method of FIG. 4A for server-side playback of the live stream and associated secondary media content items, which may provide the benefits of reduced client-side latency and decreased server and network load. Furthermore, the streaming platform may use a CDN (e.g., CDN 142 of FIG. 1) to cache identical media streams shared amongst many clients, which may further reduce server and network load.

In contrast to live media streams, on-demand media streams may have fewer simultaneous viewers and on-demand content items may vary substantially in format. As described with respect to FIG. 2, on-demand content items may be uploaded to the streaming platform by a variety of clients. On-demand content collections may be developed over extended periods of time (e.g., years), and thus may include older content items using legacy encoding formats as well as newer content items using state-of-the-art encoding formats. It may be impractical to transcode all on-demand content items and/or secondary media content items to maintain a consistent format within a media stream for all media streams, as the computational and storage requirements may be prohibitive. In some embodiments, a streaming platform may thus use a combination the server-side playback methods described with respect to example media streams 400 and 420 to optimize client latency, server storage and compute, and network load. For example, a streaming platform may transcode some secondary media content items to support server-side stitching for some percentage of on-demand media streams and fall back to server-side encapsulation for other on-demand media streams. In some embodiments, server-side stitching, server-side encapsulation, or a combination of methods may be useful and may provide different advantages for other types of media streams besides live and on-demand streams.

Server-side playback of primary and secondary media content may provide further benefits for developers of streaming platforms. By performing content transitions at the server rather than at each client, developers may only need to create and maintain the transition logic for the server rather than for each of the diverse variety of client devices supported by the streaming platform. Thus, developers may experience increased productivity due to reduced software maintenance requirements, and user experience may improve due to reduced prevalence of software bus and inefficiencies attributable to client-specific implementations in conventional systems.

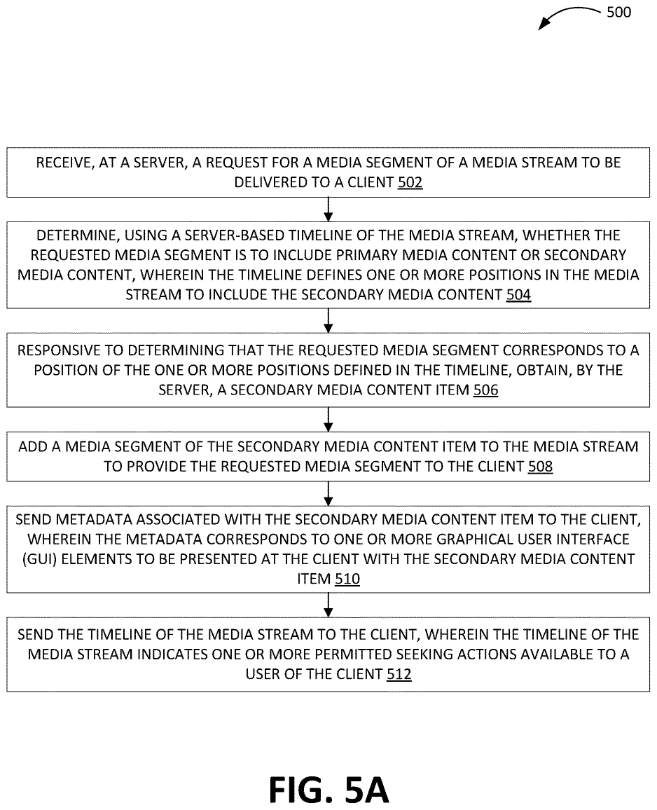

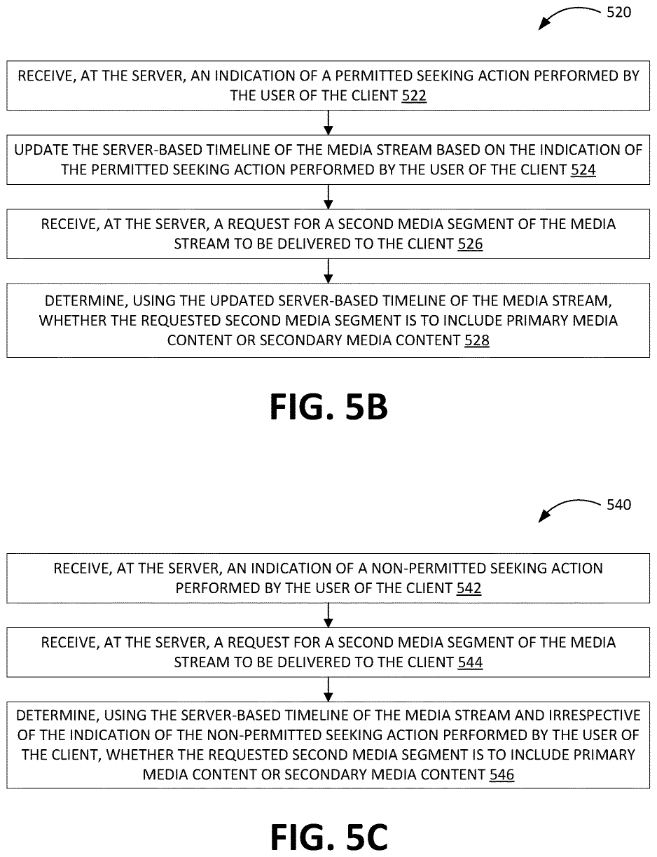

FIG. 5A is a flow diagram of an example method 500 for providing server-side initiation and playback of primary and secondary media content at a streaming platform, according to at least one embodiment. Method 500 can be performed by processing logic that can include hardware (circuitry, dedicated logic, etc.), software (e.g., instructions run on a processing device), or a combination thereof. In at least one implementation, some or all of the operations of method 500 can be performed by one or more components of streaming platform system architecture 100 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 502, processing logic receives, at a server, a request for a media segment of a media stream to be delivered to a client. In some embodiments, the request for the media segment may be received at streaming server 112, CDN 142, or at a combination of server machines 110-140 of FIG. 1. The request may be received from a client device, such as one of client devices 102A-N. The request for the media segment may be agnostic with respect to the type of media content to be delivered (e.g., primary or secondary), or may specify a type of media content. The request for the media segment may include timeline-related data, such the starting time and ending time (or length) of the media segment to deliver, the ending time of the last media segment in the local buffer, indications of user or non-user seeking activity (e.g., skipping a secondary media content item), etc. The request may include other data and metadata, e.g., relating to secondary media streams (e.g., audio or captions), client capabilities (e.g., supported codecs), network or device conditions, etc. In some embodiments, the request may be a first request for a media segment. The request may specify a primary media content item to stream and may cause the streaming platform to obtain the primary media content item (e.g., from data store 106) and create a server-side timeline (e.g., on timeline server 122). In some embodiments, the request may be a next request for a media segment, following a previous request for a media segment.

At block 504, processing logic determines, using a server-based timeline of the media stream, whether the requested media segment is to include primary media content or secondary media content, wherein the timeline defines one or more positions in the media stream to include the secondary media content. In some embodiments, the server-based timeline may be media stream timeline 124 of timeline server 122 of FIG. 1 or one of media stream timelines 300 and 320 of FIGS. 3A-B. Streaming server 112 or timeline server 122 may query the timeline to determine the current playback position and whether the media content at that position is primary media content or secondary media content. The media content at the current playback position may be a media content item or a placeholder for a yet-to-be-determined media content item. Furthermore, the timeline may include one or more placeholders for the one or more positions in the media stream to include the secondary media content. In some embodiments, additional data from the request of block 502 may be used to query the timeline. For example, the request may specify a new current playback position or user seeking action, which may be used to update the timeline before determining whether the media content item at the current playback position is primary media content or secondary media content. In some embodiments, the server-based timeline is synchronized to a plurality of timeline servers, such as timeline servers replicated on one or more CDN nodes.

At block 506, responsive to determining that the requested media segment corresponds to a position of the one or more positions defined in the timeline, processing logic obtains, by the server, a secondary media content item. In some embodiments, the server (e.g., streaming server 112) may obtain the secondary media content item from data store 106. In some embodiments, the server may obtain the secondary media content item from a secondary media content server such as secondary content server 132 of FIG. 1. The server may request selection of one of a plurality of secondary media content items by the secondary media content server. For example, the server may request the secondary content server to run an ad auction to select an advertisement from a collection of advertisements, or the server may request the secondary content server to select a survey from a list of currently available surveys. In some embodiments, the server may receive an indication of the selected secondary media content item from the secondary media content server (e.g., a content ID, a pointer to the content). The server may then obtain the selected secondary media content item from data store 106 or elsewhere. In some embodiments, the server may receive the secondary media content item from the secondary media content server. In some embodiments, the server may reuse a selected secondary media content item or indication thereof from a previous request to the secondary media content server, thus reducing the load on the secondary media content server.

At block 508, processing logic adds a media segment of the secondary media content item to the media stream to provide the requested media segment to the client. In some embodiments, the added media segment may be a plurality of bytes, packets (e.g., network packets), or other type of data. In some embodiments, the added media segment may be encoded in a streaming-compatible format, such as H.264/AVC, VP9, H.265/HEVC, AV1, ACC, MP3, etc.

In some embodiments, a previous media segment of the media stream is associated with a first format, and the media segment of the secondary media content item to be added to the media stream is also associated with the first format. Adding the media segment of the secondary media content item to the media stream may further comprise appending the media segment of the secondary media content item to the previous media segment (e.g., as described with respect to FIG. 4A) to form a continuous plurality of media segments in the first format, such that a decoder of the client (e.g., media decoder 202 of FIG. 2) that is configured to decode the previous media segment in the first format will also decode the media segment of the secondary media content item in the first format without reinitialization of the decoder.

In some embodiments, a previous media segment of the media stream is associated with a first format, and the media segment of the secondary media content item to be added to the media stream is associated with a second format. Adding the media segment of the secondary media content item to the media stream may further comprise prepending an initialization segment to the media segment of the secondary media content item. The media segment of the secondary media content item with the prepended initialization segment may be appended to the previous media segment (e.g., as described with respect to FIG. 4B) to form a continuous plurality of media segments. In some embodiments, the initialization segment causes the client to reinitialize a decoder of the client (e.g., media decoder 202 of FIG. 2) to decode the second format, wherein the decoder was previously configured to decode the first format. In some embodiments, the initialization segment causes the client to initialize a second decoder of the client to decode the second format. In some embodiments, the initialization segment causes the client to reinitialize a media player or initialize a second media player (e.g., media player 206 of FIG. 2) to play the media segment of the secondary media content item in the second format.

In some embodiments, processing logic may apply DRM protection to the media segment or the media stream. For example, processing logic may generate a DRM encryption key and encrypt the media stream before providing the requested media segment to the client. Processing logic may send a complementary DRM decryption key to the client for removing DRM protection before presenting the media stream to a user.

At block 510, processing logic sends metadata associated with the secondary media content item to the client, wherein the metadata corresponds to one or more graphical user interface (GUI) elements to be presented at the client with the secondary media content item. In some embodiments, the metadata may indicate to the client that the media segment provided at block 508 is a segment of a secondary media content item, as the client may not otherwise be able to distinguish between primary and secondary media content in the media stream. The client may retrieve one or more GUI elements from local or remote storage to present in association with the secondary media content. For example, the GUI element(s) may be a “skip ad” button, a set of radio buttons for a survey, one or more hyperlinks linking to other media content, etc. In some embodiments, the metadata may include the GUI elements to be presented at the client. For example, the metadata may include HTML, CSS, XML, JavaScript, etc. to be inserted into the client's GUI. In some embodiments, the metadata may cause the client to perform actions such as logging events in association with the secondary media content item.

At block 512, processing logic sends the timeline of the media stream to the client, wherein the timeline of the media stream indicates one or more permitted seeking actions available to a user of the client. In some embodiments, as described with respect to FIG. 1, the timeline may be media stream timeline 124, and the timeline may be sent from streaming server 112 or timeline server 122. The timeline sent to the client may be a copy of media stream timeline 124 or may include more information or less information. In some embodiments, the timeline may indicate one or more permitted seeking actions or other actions (e.g., skip, pause, seek forward, seek backward, 2× speed) with respect to each primary and secondary media content item in the timeline. Permitted seeking actions may also be relative to other content items in the timeline. For example, a permitted seeking action may be to seek forward, but only up until the next secondary media content item. In some embodiments, the timeline may indicate one or more non-permitted seeking actions, such as seeking forward during a secondary media content item.

FIG. 5B is a flow diagram of an example method 520 for providing server-side initiation and playback of primary and secondary media content at a streaming platform, according to at least one embodiment. Method 520 can be performed by processing logic that can include hardware (circuitry, dedicated logic, etc.), software (e.g., instructions run on a processing device), or a combination thereof. In at least one implementation, some or all of the operations of method 500 can be performed by one or more components of streaming platform system architecture 100 of FIG. 1. In some embodiments, method 520 may be performed in response to performing block 512 of FIG. 5A.

At block 522, processing logic receives, at the server, an indication of a permitted seeking action performed by the user of the client. For example, the indication may specify that the user skipped a secondary media content item or jumped forward a certain amount of time. It some embodiments, the indication of a permitted seeking action may be received along with a request for a media segment (e.g., with block 526 below).

At block 524, processing logic updates the server-based timeline of the media stream based on the indication of the permitted seeking action performed by the user of the client. For example, processing logic may move the current playback position of the server-based timeline forward or backward to reflect the seeking action. In another example, the timeline may allocate a fixed amount of time for secondary media content at a position, and the permitted action may skip the first selected secondary media content item for that position. Updating the server-based timeline may thus include selecting a new secondary media content item to fill that position rather than seeking past that position.

At block 526, processing logic receives, at the server, a request for a second media segment of the media stream to be delivered to the client. The request received at block 526 may have similar characteristics as described with respect to the request received at block 502. As described with respect to block 522, the request may also indicate a permitted seeking action, which may require a subsequent update to the server-based timeline.

At block 528, processing logic determines, using the updated server-based timeline of the media stream, whether the requested second media segment is to include primary media content or secondary media content. The determination at block 528 may be similar to the determination described with respect to block 504 but using the updated timeline. Method 520 may proceed to obtain secondary media content and add a media segment to the media stream as described with respect to blocks 506 and 508 and may further receive subsequent requests for additional media segments.

FIG. 5C is a flow diagram of an example method 540 for providing server-side initiation and playback of primary and secondary media content at a streaming platform, according to at least one embodiment. Method 540 can be performed by processing logic that can include hardware (circuitry, dedicated logic, etc.), software (e.g., instructions run on a processing device), or a combination thereof. In at least one implementation, some or all of the operations of method 500 can be performed by one or more components of streaming platform system architecture 100 of FIG. 1. In some embodiments, method 540 may be performed in response to performing block 512 of FIG. 5A.

At block 542, processing logic receives, at the server, an indication of a non-permitted seeking action performed by the user of the client. For example, the indication may specify that the user attempted to skip a secondary media content item or jumped forward a beyond a permitted time range. It some embodiments, the indication of a non-permitted seeking action may be received along with a request for a media segment (e.g., with block 544 below).

At block 544, processing logic receives, at the server, a request for a second media segment of the media stream to be delivered to the client. The request received at block 544 may have similar characteristics as described with respect to the request received at block 502. As described with respect to block 542, the request may also indicate a non-permitted seeking action.

At block 546, processing logic determines, using the server-based timeline of the media stream and irrespective of the indication of the non-permitted seeking action performed by the user of the client, whether the requested second media segment is to include primary media content or secondary media content. The determination at block 546 may be similar to the determination described with respect to block 504, as the non-permitted seeking action does not result in an update to the server-based timeline. Method 540 may proceed to obtain secondary media content and add a media segment to the media stream as described with respect to blocks 506 and 508 and may further receive subsequent requests for additional media segments.

FIG. 6 is a block diagram illustrating an exemplary computer system 600, in accordance with implementations of the present disclosure. The computer system 600 can correspond to client devices 102A-N and/or server machines 110-140 described with respect to FIG. 1 The computer system 600 can also correspond to client device 200 described with respect to FIG. 2. Computer system 600 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 618, which communicate with each other via a bus 640.

Processor (processing device) 602 represents one or more general-purpose processing devices such as a microprocessor, central processing unit, or the like. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 605 (e.g., for providing automatic rule generation and data-driven detection engineering systems) for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 620 (e.g., a speaker). In some embodiments, computer system 600 may not include video display unit 610, input device 612, and/or cursor control device 614 (e.g., in a headless server configuration).

The data storage device 618 can include a non-transitory machine-readable storage medium 624 (also computer-readable storage medium) on which is stored one or more sets of instructions 605 (e.g., for providing automatic rule generation and data-driven detection engineering systems) embodying any one or more of the methodologies or functions described herein. The instructions can also reside, completely or at least partially, within the main memory 604 and/or within the processor 602 during execution thereof by the computer system 600, the main memory 604 and the processor 602 also constituting machine-readable storage media. The instructions can further be transmitted or received over a network 630 via the network interface device 608.

In one implementation, the instructions 605 include instructions for providing automatic rule generation and data-driven detection engineering systems. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors), software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving, at a server, a request for a media segment of a media stream to be delivered to a client;
determining, using a server-based timeline of the media stream, whether the requested media segment is to include primary media content or secondary media content, wherein the timeline defines one or more positions in the media stream to include the secondary media content;
responsive to determining that the requested media segment corresponds to a position of the one or more positions defined in the timeline, obtaining, by the server, a secondary media content item; and
adding a media segment of the secondary media content item to the media stream to provide the requested media segment to the client.

2. The method of claim 1, further comprising sending metadata associated with the secondary media content item to the client, wherein the metadata corresponds to one or more graphical user interface (GUI) elements to be presented at the client with the secondary media content item.

3. The method of claim 1, further comprising sending the timeline of the media stream to the client, wherein the timeline of the media stream indicates one or more permitted seeking actions available to a user of the client.

4. The method of claim 3, further comprising:
receiving, at the server, an indication of a permitted seeking action performed by the user of the client;
updating the server-based timeline of the media stream based on the indication of the permitted seeking action performed by the user of the client;
receiving, at the server, a request for a second media segment of the media stream to be delivered to the client, and
determining, using the updated server-based timeline of the media stream, whether the requested second media segment is to include primary media content or secondary media content.

5. The method of claim 3, further comprising:
receiving, at the server, an indication of a non-permitted seeking action performed by the user of the client;
receiving, at the server, a request for a second media segment of the media stream to be delivered to the client; and
determining, using the server-based timeline of the media stream and irrespective of the indication of the non-permitted seeking action performed by the user of the client, whether the requested second media segment is to include primary media content or secondary media content.

6. The method of claim 1, wherein obtaining the secondary media content item further comprises:
requesting, by the server, selection of one of a plurality of secondary media content items by a secondary media content server; and
receiving the secondary media content item from the secondary media content server.

7. The method of claim 1, wherein a previous media segment of the media stream is associated with a first format, wherein the media segment of the secondary media content item is associated with a second format, wherein adding the media segment of the secondary media content item to the media stream further comprises prepending an initialization segment to the media segment of the secondary media content item, and wherein the initialization segment causes the client to reinitialize a decoder of the client to decode the second format.

8. The method claim 1, wherein the server-based timeline is synchronized to a plurality of timeline servers.

9. A system comprising:
a memory device; and
a processing device coupled to the memory device, the processing device to perform operations comprising:
receiving, at a server, a request for a media segment of a media stream to be delivered to a client:
determining, using a server-based timeline of the media stream, whether the requested media segment is to include primary media content or secondary media content, wherein the timeline defines one or more positions in the media stream to include the secondary media content:
responsive to determining that the requested media segment corresponds to a position of the one or more positions defined in the timeline, obtaining, by the server, a secondary media content item; and
adding a media segment of the secondary media content item to the media stream to provide the requested media segment to the client.

10. The system of claim 9, the operations further comprising sending the timeline of the media stream to the client, wherein the timeline of the media stream indicates one or more permitted seeking actions available to a user of the client.

11. The system of claim 10, the operations further comprising:
receiving, at the server, an indication of a permitted seeking action performed by the user of the client;
updating the server-based timeline of the media stream based on the indication of the permitted seeking action performed by the user of the client;
receiving, at the server, a request for a second media segment of the media stream to be delivered to the client, and
determining, using the updated server-based timeline of the media stream, whether the requested second media segment is to include primary media content or secondary media content.

12. The system of claim 10, the operations further comprising:
receiving, at the server, an indication of a non-permitted seeking action performed by the user of the client,
receiving, at the server, a request for a second media segment of the media stream to be delivered to the client; and
determining, using the server-based timeline of the media stream and irrespective of the indication of the non-permitted seeking action performed by the user of the client, whether the requested second media segment is to include primary media content or secondary media content.

13. The system of claim 9, wherein obtaining the secondary media content item further comprises:
requesting, by the server, selection of one of a plurality of secondary media content items by a secondary media content server; and
receiving the secondary media content item from the secondary media content server.

14. The system of claim 9, wherein a previous media segment of the media stream is associated with a first format, wherein the media segment of the secondary media content item is associated with a second format, wherein adding the media segment of the secondary media content item to the media stream further comprises prepending an initialization segment to the media segment of the secondary media content item, and wherein the initialization segment causes the client to reinitialize a decoder of the client to decode the second format.

15. A non-transitory computer-readable medium comprising instructions that, when executed by a processing device, cause the processing device to perform operations comprising:
receiving, at a server, a request for a media segment of a media stream to be delivered to a client;
determining, using a server-based timeline of the media stream, whether the requested media segment is to include primary media content or secondary media content, wherein the timeline defines one or more positions in the media stream to include the secondary media content;
responsive to determining that the requested media segment corresponds to a position of the one or more positions defined in the timeline, obtaining, by the server, a secondary media content item; and
adding a media segment of the secondary media content item to the media stream to provide the requested media segment to the client.

16. The non-transitory computer-readable medium of claim 15, the operations further comprising sending the timeline of the media stream to the client, wherein the timeline of the media stream indicates one or more permitted seeking actions available to a user of the client.

17. The non-transitory computer-readable medium of claim 16, the operations further comprising:
receiving, at the server, an indication of a permitted seeking action performed by the user of the client;
updating the server-based timeline of the media stream based on the indication of the permitted seeking action performed by the user of the client;
receiving, at the server, a request for a second media segment of the media stream to be delivered to the client; and
determining, using the updated server-based timeline of the media stream, whether the requested second media segment is to include primary media content or secondary media content.

18. The non-transitory computer-readable medium of claim 16, the operations further comprising:
receiving, at the server, an indication of a non-permitted seeking action performed by the user of the client;
receiving, at the server, a request for a second media segment of the media stream to be delivered to the client; and
determining, using the server-based timeline of the media stream and irrespective of the indication of the non-permitted seeking action performed by the user of the client, whether the requested second media segment is to include primary media content or secondary media content.

19. The non-transitory computer-readable medium of claim 15, wherein obtaining the secondary media content item further comprises:
requesting, by the server, selection of one of a plurality of secondary media content items by a secondary media content server; and
receiving the secondary media content item from the secondary media content server.

20. The non-transitory computer-readable medium of claim 15, wherein a previous media segment of the media stream is associated with a first format, wherein the media segment of the secondary media content item is associated with a second format, wherein adding the media segment of the secondary media content item to the media stream further comprises prepending an initialization segment to the media segment of the secondary media content item, and wherein the initialization segment causes the client to reinitialize a decoder of the client to decode the second format.
